(19) United States
(12) Patent Application Publication
(10) Pub. No.: US 2023/0262369 A1
(43) Pub. Date: Aug. 17, 2023

(54) SERVICE DATA TRANSMISSION METHOD, COMMUNICATION NETWORK, SERVICE RECEIVING DEVICE, AND STORAGE MEDIUM

(71) Applicant: HUAWEI TECHNOLOGIES CO., LTD., Shenzhen (CN)

(72) Inventors: Yu ZHENG, Dongguan (CN); Wei CHEN, Wuhan (CN)

(21) Appl. No.: 18/307,163

(22) Filed: Apr. 26, 2023

Related U.S. Application Data
(63) Continuation of application No. PCT/CN2021/104916, filed on Jul. 7, 2021.

(30) Foreign Application Priority Data
Oct. 31, 2020 (CN) 202011197165.4

(51) Int. Cl. H04Q 11/00; H04L 45/00

(52) U.S. Cl. CPC H04Q 11/0003; H04L 45/66

(57) ABSTRACT

A service data transmission method, to simplify a structure of a communication network and facilitate planning of the communication network by service planning personnel. The method includes: A service receiving device actively sends a MAC address of the service receiving device to a plurality of service sending devices that have a connection relationship with the service receiving device, and each service sending device configures local routing information based on the MAC address. The MAC address of the service receiving device does not need to be obtained based on an ARP request, avoiding a limitation on an IP address of a device port caused by the ARP request. An IP address of one device is used to replace IP addresses of a plurality of ports of the device, simplifying a communication network.

### CROSS-REFERENCE TO RELATED APPLICATIONS

This application is a continuation of International Application No. PCT/CN2021/104916, filed on Jul. 7, 2021, which claims priority to Chinese Patent Application No. 202011197165.4, filed on Oct. 31, 2020. The disclosures of the aforementioned applications are hereby incorporated in entirety by reference.

### BACKGROUND

In a communication network, a first port of a service sending device has a first internet protocol (IP) address. A second port of a service receiving device has a second IP address. To send service data to the service receiving device, the service sending device needs to obtain a media access control (MAC) address of the second port. A process is as follows: The service sending device broadcasts an address resolution protocol (ARP) request in a network segment of the first IP address based on an ARP. The request carries the second IP address. The service receiving device receives the ARP request through the second port having the second IP address, and sends the MAC address of the second port to the service sending device.

The ARP request from the service sending device arrives at a port in the same network segment as the first IP address. In response to the first port and the second port being in different network segments, the service receiving device is unable to receive the ARP request through the second port, and consequently does not send the MAC address of the second port to the service sending device. In this case, the service sending device is unable to obtain the MAC address of the second port, resulting in unsuccessful sending of the service data.

To implement successful sending of the service data, each pair of a service receiving device and a service sending device has a first IP address and a second IP address that are in a same network segment calls to be ensured. In response to there being a plurality of service sending devices and a plurality of service receiving devices, each service sending device needs to have a plurality of first IP addresses, that is, a plurality of first ports. Each service receiving device needs to have a plurality of second IP addresses, that is, a plurality of second ports. Each device has a plurality of ports, and a structure of the communication network is complex.

### SUMMARY

Some embodiments provide a service data transmission method, a communication network, a service receiving device, and a storage medium, to simplify a structure of a communication network and reduce complexity of the structure of the communication network.

In some embodiments, a service data transmission method is provided. The method is applied to a communication network. The communication network includes n service receiving devices and m service sending devices, and both n and m are integers greater than or equal to 1. The method includes the following steps. Any one of the n service receiving devices is referred to as a first service receiving device in some embodiments. The first service receiving device broadcasts a MAC address of the first service receiving device to any service sending device having a connection relationship with the first service receiving device. The first service receiving device broadcasts a first MAC address to each of the m service sending devices. In some embodiments, the MAC address of the first service receiving device is also referred to as the first MAC address. After receiving the first MAC address, each service sending device configures local routing information based on the first MAC address. At least one of the m service sending devices sends service data and the first MAC address to the first service receiving device based on the configured local routing information.

In some embodiments, the service sending device receives the MAC address of the service receiving device provided that the service sending device has the connection relationship with the service receiving device. The service sending device configures the local routing information based on the MAC address of the service receiving device. The service sending device successfully sends the service data based on the local routing information. Regardless of that the service sending device obtains the MAC address of the service receiving device or that the service sending device sends the service data to the service receiving device, network segments of IP addresses of the service sending device and the service receiving device do not constitute any limitation. Each service sending device or service receiving device does not need to have a plurality of ports in different network segments, and a structure of the communication network is simpler. Planning personnel do not need to ensure that each pair of a service sending device and a service receiving device has ports in a same network segment, allowing planning more convenient.

In some embodiments, the service receiving device sends the first MAC address to each of the m service sending devices via a first data frame. The first data frame includes a first field. The first field carries the first MAC address.

In some embodiments, the first MAC address is transmitted via the first field in the first data frame. A location of the first MAC address is restricted in a particular field. A non-particular field is not occupied, and impact on another communication method in the communication network is reduced.

In some embodiments, the communication network is an optical transport network (OTN). The OTN is for transmitting an OTN frame. The OTN frame includes a payload area and an overhead area. The payload area is for transmitting the service data, and the overhead area is for transmitting data other than the service data. To transmit the service data, a MAC address corresponding to the service receiving device in the payload area needs to be obtained. The service receiving device sends, to the service sending device, an OTN frame used as the first data frame. The first field in an overhead area of the OTN frame carries a MAC address corresponding to the service receiving device in a payload area, namely, the first MAC address.

In some embodiments, provided that the service receiving device has the connection relationship with the service sending device, data is sent from the service receiving device to the service sending device via the overhead area of the OTN frame. Even in response to an IP address corresponding to a port of the service receiving device in the payload area and an IP address corresponding to a port of the service sending device in the payload area are in different network segments, the service sending device still receives, via the overhead area, the MAC address corresponding to the service receiving device in the payload area. Transmission of the MAC address of the service receiving device is no longer limited by a network segment of an IP address of a port. The IP address of the port is set freely, so that difficulty of planning the IP address by a planning person is reduced.

In some embodiments, the first field includes at least one of a field GCC 0, a field GCC 1, or a field GCC 2.

In some embodiments, the first MAC address is transmitted by using an extended protocol. The first field carries a packet of the extended protocol. The packet of the extended protocol indicates the first MAC address. The packet of the extended protocol includes a first data fragment. The first data fragment indicates the first MAC address.

In some embodiments, the first MAC address is transmitted by extending an existing protocol. An existing communication network is slightly changed, and costs of changing a structure of the communication network are low.

In some embodiments, the extended protocol includes a path computation element communication protocol (PCEP) or a border gateway protocol (BGP).

In some embodiments, in response to there being a plurality of service receiving devices in the communication network, a quantity of messages that are for transmitting MAC addresses of the service receiving devices and that are in the communication network is reduced by using a transit device. The transit device receives n MAC addresses from the n service receiving devices. The n MAC addresses are different from each other, and the n MAC addresses are in one-to-one correspondence with MAC addresses of the n service receiving devices. For example, an x^{th} service receiving device is any one of the n service receiving devices. The x^{th} service receiving device sends an x^{th} MAC address to the transit device. The x^{th} MAC address is a MAC address of the x^{th} service receiving device. x is any integer greater than or equal to 1 and less than or equal to n. After receiving the n MAC addresses sent by the n service receiving devices, the transit device forwards a transit message to each service sending device. Each transit message includes the n MAC addresses, and the n MAC addresses are in one-to-one correspondence with the n service receiving devices. Each service sending device configures the local routing information based on the n MAC addresses. The local routing information corresponds to the n service receiving devices. Each service sending device configures, based on the x^{th} MAC address, local routing information related to the x^{th} service receiving device.

In some embodiments, in response to there being no transit device, the n service receiving devices send the MAC addresses of the service receiving devices to the m service sending devices, that is, a total of m*n messages need to be sent. With the transit device, the n service receiving devices need to send a total of m+n messages, to send the MAC addresses of the service receiving devices to the m service sending devices. In response to both m and n being integers greater than 1, m*n>m+n. The transit device sends the MAC addresses of the service receiving devices, so that a quantity of messages in the communication network is reduced, and a bandwidth of the communication network is saved.

In some embodiments, the transit device sends a second data frame to each of the m service sending devices. The second data frame includes a second field. The second field indicates a MAC address of each of the n service receiving devices.

In some embodiments, the MAC address of each service receiving device is transmitted via the second field in the second data frame. A location of the MAC address of each service receiving device is restricted in a particular field. A non-particular field is not occupied, and impact on another communication method in the communication network is reduced.

In some embodiments, the communication network is an OTN. The transit device sends, to each service sending device, an OTN frame used as the second data frame. The second field is in an overhead area of the OTN frame. The second field carries a MAC address corresponding to the service receiving device in a payload area, namely, the first MAC address.

In some embodiments, the transit device is at least one of the following: a software-defined networking SDN controller, a server, or a network element.

In some embodiments, the transit device sends the n MAC addresses to a service sending device. The transit device stores a mapping relationship between a service receiving device and a service sending device. The transit device sends the n MAC addresses to the service sending device that has the mapping relationship with the service receiving device.

In some embodiments, the transit device does not send the MAC addresses of the n service receiving devices to a service sending device that has no mapping relationship with the service receiving device, so that the service sending devices are screened. The transit device sends the MAC addresses of the n service receiving devices to the service sending device, so that the quantity of messages in the communication network is reduced, and the bandwidth of the communication network is saved.

In some embodiments, the MAC address and a device identifier of the service receiving device are sent together. The service sending device configures the local routing information based on the device identifier and the MAC address. The service sending device receives the x^{th} MAC address and an x^{th} device identifier from the x^{th} service receiving device. The service sending device fills the x^{th} device identifier and the x^{th} MAC address in an ARP table. To send the service data to the x^{th} service receiving device, the service sending device queries a routing table to obtain the x^{th} device identifier, and then queries the ARP table to obtain the x^{th} MAC address.

In some embodiments, the MAC address and the device identifier of the service receiving device are filled in the ARP table of the service sending device. The MAC address of the service receiving device is obtained through querying based on the device identifier, the ARP table, and the routing table. An ARP technology used in most communication networks is used. An existing communication network is slightly changed, and costs of changing a structure of the communication network are low.

In some embodiments, the device identifier of the service receiving device is an IP address of the service receiving device, and identifies the service receiving device.

In some embodiments, the service receiving device is identified based on the IP address of the device, instead of IP addresses of a plurality of ports. The sending device needs to configure the routing information based on one device IP address of the service receiving device, and does not need to configure the routing information for a plurality of ports of a same service receiving device. In the communication network, the same service receiving device does not need the plurality of ports, and the structure of the communication network is simpler. The service sending device configures the routing information by using the IP address. The IP address of the device is used to replace IP addresses of the plurality of ports, and configuration of the routing information by the service sending device is simpler. A quantity of messages that are sent in the communication network and that include the IP address of the service receiving device or the IP address of the port of the service receiving device is reduced, so that the bandwidth of the communication network is saved.

In some embodiments, a data transmission method is provided. The method includes the following steps. Any one of n service receiving devices is referred to as a first service receiving device in some embodiments. The first service receiving device broadcasts a MAC address of the first service receiving device to any service sending device having a connection relationship with the first service receiving device. The first service receiving device broadcasts the MAC address of the first service receiving device to each service sending device in m service sending devices. In some embodiments, the MAC address of the first service receiving device is also referred to as the first MAC address. The first MAC address is used by each sending device to configure local routing information. The first service receiving device receives service data and the first MAC address from at least one service sending device. The at least one service sending device is at least one of the m service sending devices. The service data and the first MAC address are sent based on the configured local routing information.

In some embodiments, the first service receiving device sends the first MAC address to each of the m service sending devices via a first data frame. The first data frame includes a first field. The first field carries the first MAC address.

A communication network is an optical transport network OTN. The OTN is for transmitting an OTN frame. The OTN frame includes a payload area and an overhead area. The payload area is for transmitting the service data, and the overhead area is for transmitting data other than the service data. To transmit the service data, a MAC address corresponding to the receiving device in the payload area needs to be obtained. The receiving device sends the OTN frame to the sending device, where the overhead area of the OTN frame carries the MAC address corresponding to the receiving device in the payload area.

In some embodiments, the first service receiving device is a device in the optical transport network OTN. The service receiving device sends and receive an OTN frame. The OTN frame includes a payload area and an overhead area. The payload area is for transmitting the service data, and the overhead area is for transmitting data other than the service data. To transmit the service data, a MAC address corresponding to the service receiving device in the payload area needs to be obtained. The service receiving device sends, to the service sending device, an OTN frame used as the first data frame. The first field in an overhead area of the OTN frame carries a MAC address corresponding to the service receiving device in a payload area, namely, the first MAC address.

In some embodiments, the first field includes at least one of a field GCC 0, a field GCC 1, or a field GCC 2.

In some embodiments, the first MAC address is transmitted by using an extended protocol. The first field carries a packet of the extended protocol. The packet of the extended protocol indicates the first MAC address. The packet of the extended protocol includes a first data fragment. The first data fragment indicates the first MAC address.

In some embodiments, the extended protocol includes a path computation element communication protocol (PCEP) or a border gateway protocol (BGP).

In some embodiments, in response to there being a plurality of service receiving devices, a quantity of messages used by the service receiving devices to send MAC addresses are reduced by using a transit device. In response to a quantity of service receiving devices being n, where n is an integer greater than or equal to 2, the n service receiving devices send n MAC addresses to the transit device. The n MAC addresses are different from each other, and the n MAC addresses are in one-to-one correspondence with MAC addresses of the n service receiving devices. The n MAC addresses are forwarded to each of the m service sending devices. For example, an x^{th} service receiving device is any one of the n service receiving devices. x is any integer greater than or equal to 1 and less than or equal to n. The x^{th} service receiving device sends an x^{th} MAC address to the transit device. The x^{th} MAC address is a MAC address of the x^{th} service receiving device. The x^{th} MAC address is forwarded by the transit device to the service sending device, so that the service sending device configures the local routing information based on the x^{th} MAC address.

In some embodiments, the transit device is at least one of the following: a software-defined networking SDN controller, a server, or a network element.

In some embodiments, the transit device sends the n MAC addresses to a service sending device. The transit device stores a mapping relationship between a service receiving device and a service sending device. The transit device sends the n MAC addresses to the service sending device that has the mapping relationship with the service receiving device.

In some embodiments, the MAC address and a device identifier of the service receiving device are sent together. The device identifier and the MAC address are used by the service sending device to configure the local routing information.

In some embodiments, the device identifier of the service receiving device is an IP address of the service receiving device, and identifies the service receiving device.

In some embodiments, a data transmission method is provided. The method includes the following steps.

Each of m service sending devices receives a first MAC address from a first service receiving device. The first MAC address is a MAC address of the first service receiving device. The first service receiving device is any one of n service receiving devices. The service receiving device is any device that has a connection relationship with the service sending device. After receiving the first MAC address, each service sending device configures local routing information based on the first MAC address. At least one of the m service sending devices sends service data and the first MAC address to the first service receiving device based on the configured local routing information.

In some embodiments, each of the m service sending devices receives the first MAC address from the service receiving device via a first data frame. The first data frame includes a first field. The first field carries the first MAC address.

In some embodiments, the service sending device is a device in an optical transport network OTN. The service sending device sends and receive an OTN frame. The OTN frame includes a payload area and an overhead area. The payload area is for transmitting the service data, and the overhead area is for transmitting data other than the service data. To transmit the service data, a MAC address corresponding to the service receiving device in the payload area needs to be obtained. The service sending device receives, from the service receiving device, an OTN frame used as the first data frame. The first field in an overhead area of the OTN frame carries a MAC address corresponding to the service receiving device in a payload area, namely, the first MAC address.

In some embodiments, the first field includes at least one of a field GCC 0, a field GCC 1, or a field GCC 2.

In some embodiments, the first MAC address is transmitted by using an extended protocol. The first field carries a packet of the extended protocol. The packet of the extended protocol indicates the first MAC address. The packet of the extended protocol includes a first data fragment. The first data fragment indicates the first MAC address.

In some embodiments, the extended protocol includes a path computation element communication protocol (PCEP) or a border gateway protocol (BGP).

In some embodiments, in response to there being a plurality of service receiving devices, a quantity of messages that are for transmitting MAC addresses of the service receiving devices and that are in the communication network is reduced by using a transit device. Each of the m service sending devices receives a relay message from the transit device. In response to the quantity n of service receiving devices being an integer greater than or equal to 2, each transit message includes the n MAC addresses, and the n MAC addresses are in one-to-one correspondence with the n service receiving devices. Each service sending device configures the local routing information based on the n MAC addresses. The local routing information corresponds to the n service receiving devices. Each service sending device configures, based on an x^{th} MAC address, local routing information related to an x^{th} service receiving device.

In some embodiments, each of the m service sending devices receives a second data frame from the transit device. The second data frame includes a second field. The second field indicates a MAC address of each of the n service receiving devices.

In some embodiments, the service sending device is a device in the OTN. Each service sending device receives, from the transit device, an OTN frame used as the second data frame. The second field is in an overhead area of the OTN frame. The second field carries a MAC address corresponding to the service receiving device in a payload area, namely, the first MAC address.

In some embodiments, the transit device is at least one of the following: a software-defined networking SDN controller, a server, or a network element.

In some embodiments, the service sending device is particular. The transit device stores a mapping relationship between a service receiving device and a service sending device. The service sending device that has the mapping relationship with the service receiving device receives the n MAC addresses from the transit device.

In some embodiments, the MAC address and a device identifier of the receiving device are received together. The service sending device configures the local routing information based on the device identifier and the MAC address. The service sending device receives the x^{th} MAC address and an x^{th} device identifier from the x^{th} service receiving device. The service sending device fills the x^{th} device identifier and the x^{th} MAC address in an ARP table. To send the service data to the x^{th} service receiving device, the service sending device queries a routing table to obtain the x^{th} device identifier, and then queries the ARP table to obtain the x^{th} MAC address.

In some embodiments, the device identifier of the service receiving device is an IP address of the service receiving device, and identifies the service receiving device.

In some embodiments, a computer-readable storage medium is provided. The computer-readable storage medium stores a program, and in response to the program being executed by a computer, the computer performs the method in some embodiments.

In some embodiments, a computer-readable storage medium is provided. The computer-readable storage medium stores a program, and in response to the program being executed by a computer, the computer performs the method in some embodiments.

In some embodiments, a computer-readable storage medium is provided. The computer-readable storage medium stores a program, and in response to the program being executed by a computer, the computer performs the method in some embodiments.

In some embodiments, a computer program product is provided. In response to the computer program product running on a computer, the computer performs the method in some embodiments.

In some embodiments, a computer program product is provided. In response to the computer program product running on a computer, the computer performs the method in some embodiments.

In some embodiments, a computer program product is provided. In response to the computer program product running on a computer, the computer performs the method in some embodiments.

In some embodiments, the service sending device receives the MAC address of the service receiving device provided that the service sending device has the connection relationship with the service receiving device. The service sending device configures the local routing information based on the MAC address of the service receiving device. The service sending device successfully sends the service data based on the local routing information. Regardless of that the service sending device obtains the MAC address of the service receiving device or that the service sending device sends the service data to the service receiving device, network segments of IP addresses of the service sending device and the service receiving device do not constitute any limitation. Each service sending device or service receiving device does not need to have a plurality of ports in different network segments, and a structure of the communication network is simpler. Planning personnel do not need to ensure that each pair of a service sending device and a service receiving device has ports in a same network segment, allowing planning more convenient.

### BRIEF DESCRIPTION OF DRAWINGS

FIG. 1 is an architectural diagram of a communication network according to some embodiments;

FIG. 2 is an architectural diagram of an optical transport network OTN according to some embodiments;

FIG. 3 is an architectural diagram of an OTN according to some embodiments;

FIG. 4 is a schematic flowchart of a data transmission method according to some embodiments;

FIG. 5 is a schematic diagram of a format of an extended BGP protocol packet according to some embodiments;

FIG. 6 is an architectural diagram of a communication network according to some embodiments;

FIG. 7 is a schematic flowchart of a data transmission method according to some embodiments;

FIG. 8 is a schematic diagram of a structure of a communication network according to some embodiments;

FIG. 9 is a schematic diagram of a structure of a service receiving device according to some embodiments; and

FIG. 10 is a schematic diagram of a structure of a service sending device according to some embodiments.

### DESCRIPTION OF EMBODIMENTS

Some embodiments provide a service data transmission method, to simplify a structure of a communication network and reduce complexity of the structure of the communication network.

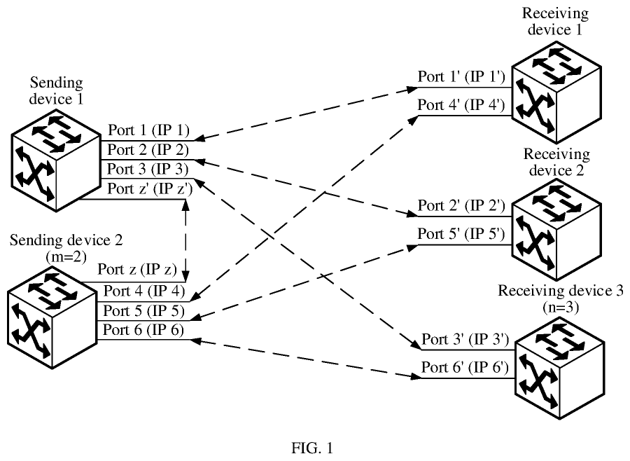

FIG. 1 is an architectural diagram of a communication network according to some embodiments. The communication network includes a plurality of service sending devices and a plurality of service receiving devices. In the communication network, each service sending device from a service sending device 1 to a service sending device m has n ports. The n ports correspond to n IP addresses in different network segments. Each service receiving device from a service receiving device 1 to a service receiving device n has m ports. The m ports correspond to m IP addresses in different network segments.

In response to m=2 and n=3, each service sending device has three ports, and each service receiving device has two ports. For example, the service sending device 1 has three ports whose IP addresses are IP 1, IP 2, and IP 3. The service receiving device 1 has two ports whose IP addresses are IP 1′ and IP 4′.

Service data is transmitted provided that IP addresses in a same network segment exist between the port of the service sending device and the port of the service receiving device.

Based on this architecture, each service sending device from the service sending device 1 to the service sending device m sends a service message to each service receiving device from the service receiving device 1 to the service receiving device n. For example, the service sending device 1 in FIG. 1 sends the service data to the service receiving device 1 through a port 1 and a port 1′.

In some embodiments, a relationship between the service sending device and the service receiving device is not fixed as shown in the figure. The service sending device in FIG. 1 alternatively serves as a service receiving device, and is configured to receive a service message from another device in the communication network. For example, in response to the service sending device 1 serving as a service receiving device, the service sending device 1 receives a service message from the service receiving device 1 through the port 1 and the port 1′. The service sending devices alternatively sends data to each other. For example, the service sending device 1 alternatively receives a service message from a service sending device 2 through a port z and a port z′.

In some embodiments, m=2 and n=3 in FIG. 1 are examples of a quantity of service sending devices and a quantity of service receiving devices. m and n each is any positive integer. This is not limited herein.

In response to each port of each device in the communication network being in a same network segment, each device has one port. However, during application, the following problems exist. On one hand, in response to each of the ports being in the same network segment, a quantity of ARP requests is excessively large in response to the ARP requests being broadcast. As a result, excessive bandwidths of the communication network are occupied. On the other hand, different devices belong to different users. The different users have different conditions for a network segment of a device port. Therefore, in the communication network, most devices have a plurality of ports.

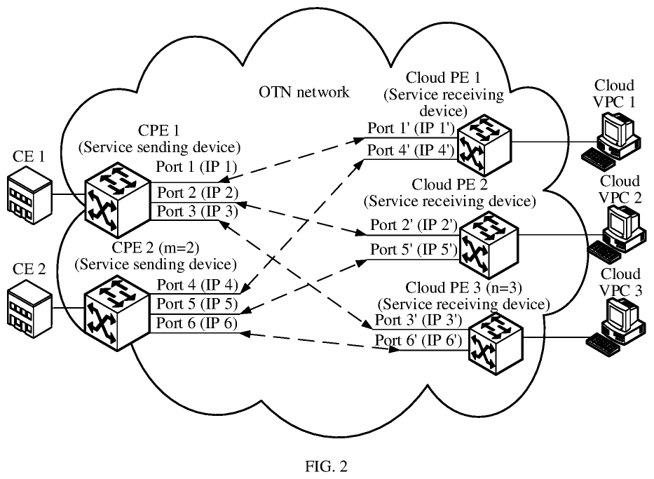

The communication network includes an optical transport network OTN. FIG. 2 is a network architectural diagram of an OTN. Data transmission between a customer edge device (CE) device and a cloud virtual machine (VPC) is implemented by the OTN. The OTN includes customer premise equipment (CPE) connected to the CE. The CE receives and sends service data via the CPE. The OTN further includes cloud premise equipment (PE) connected to the cloud VPC. The cloud VPC receives and sends service data via the cloud PE. In some embodiments, the cloud PE is also referred to as a cloud-PE, and the cloud VPC is also referred to as a VPC.

Service data transmission from a CE 1 to a VPC 1 is used as an example. To transmit service data to the VPC 1, the CE 1 needs to use CPE 1 connected to the CE 1 and cloud PE 1 connected to the VPC 1. In this case, the CPE 1 is a service sending device, and the cloud PE 1 is a service receiving device. The CPE 1 broadcasts an ARP request through a port 1, a port 2, and a port 3, to obtain a MAC address of a port of a cloud PE. Because the ARP request is restricted by a network segment of an IP address of a port, the CPE 1 and the cloud PE 1 transmits the service data through the port 1 and a port 1′ that have IP addresses in a same network segment.

In some embodiments, the CE 1 serves as a source device of the service data, and the cloud VPC 1 serves as a receiving device of the service data. The source device is a device that is connected to the service sending device and that provides the service data for the service sending device. The receiving device is a device that is connected to the service receiving device and that receives the service data from the service receiving device. The CE 1 is an example of the source device, and constitutes no limitation on the source device. For example, the source device alternatively is a cloud VPC. The cloud VPC 1 is an example of the receiving device, and constitutes no limitation on the source device and the receiving device. For example, the service receiving device alternatively is a CE.

For a service sending device, to send the service data to a plurality of service receiving devices, the service sending device needs to have a plurality of IP addresses in different network segments. In other words, the service sending device needs to have a plurality of ports. The same applies to the service receiving device. For each pair of a service receiving device and a service sending device, a port of the service sending device and a port of the service receiving device need to have IP addresses in a same network segment. From a perspective of a communication network, each device has a plurality of ports, and a structure of the communication network is complex. From a perspective of a planning person, that the port of the service sending device and the port of the service receiving device have the IP addresses in the same network segment needs to be ensured, planning difficulty is high.

To resolve the foregoing problem, some embodiments provides a service data transmission method. A MAC address of a service receiving device is broadcast to a service sending device, to transmit service data. In response to the service receiving device accessing a communication network or a topology of a communication network changes, the service receiving device actively sends the MAC address of the service receiving device to service sending devices that have a connection relationship with the service receiving device. Each of the service sending devices store the MAC address of the service receiving device, and sends the service data to the service receiving device.

In some embodiments, broadcasting in some embodiments is an action of sending same data to devices. A quantity of devices are more than one or more than two. In some embodiments, broadcasting is an action of sending a MAC address to service sending devices. The MAC address is the MAC address of the service receiving device. A quantity of service sending devices are more than one or more than two.

In some embodiments, the communication network includes m service sending devices and n service receiving devices. The service receiving device is configured to receive the service data, and the service sending device is configured to send the service data. Both m and n are integers greater than or equal to 1, and m alternatively is an integer greater than or equal to 2.

The data transmission method provided in some embodiments are applied to an optical transport network OTN. In addition to the OTN, the data transmission method provided in some embodiments alternatively is applied to another communication network, for example, an automatically switched optical network (ASON) or a packet transport network (PTN). This is not limited herein. In some embodiments, an example in which the method is applied to an OTN is used for description.

In some embodiments, the foregoing method is implemented by extending an existing point-to-point reliable transmission protocol. In some embodiments, an extended point-to-point reliable transmission protocol is also referred to as an extended protocol.

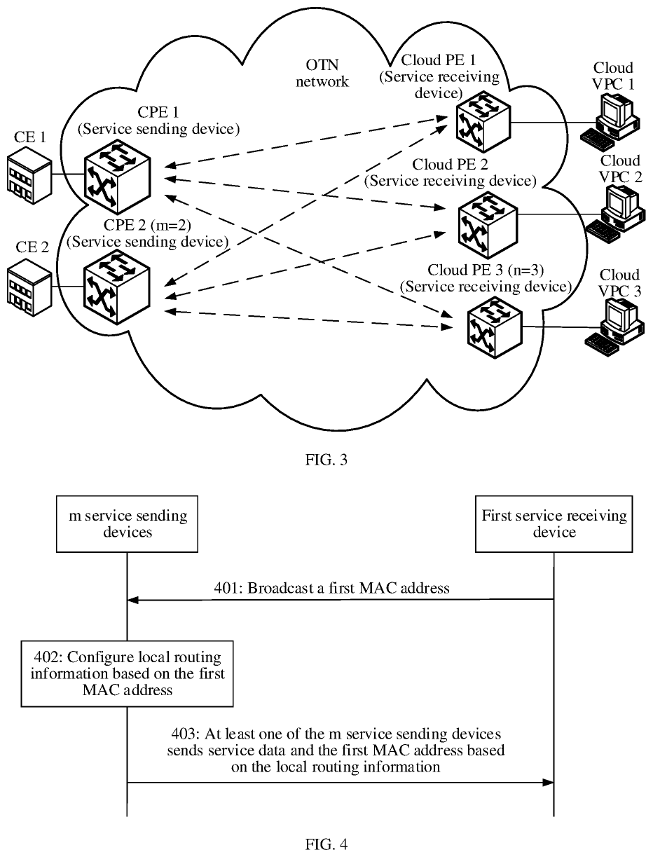

FIG. 3 is an architectural diagram of an OTN according to some embodiments. Because an IP address of a port does not need to be used in the method provided in some embodiments, a port of a device is not needed in the network architecture in FIG. 3. In comparison with the architecture of the communication network shown in FIG. 1 or FIG. 2, the port of the device does not need to be set in the architecture of the communication network in FIG. 3. The architecture of the communication network in FIG. 3 is simpler, and complexity of a structure of the communication network is low. Based on the network architecture shown in FIG. 3, a method shown in FIG. 4 is implemented.

In some embodiments, a service receiving device is CPE in the OTN, and a service sending device is cloud PE in the OTN. Alternatively, the service receiving device is cloud PE, and the service sending device is CPE. Alternatively, the service receiving device is first CPE, and the service sending device is second CPE. Alternatively, the service receiving device is first cloud PE, and the service sending device is second cloud PE. This is not limited herein.

In some embodiments, the CPE serves as the service receiving device, and the cloud PE serves as the service sending device. Some embodiments are an example of the service receiving device and the service sending device, and constitute no limitation on the service receiving device and the service sending device.

The following uses an example in which the communication network is an OTN and the extended protocol is a border gateway protocol BGP. Refer to FIG. 4. Based on the OTN architecture shown in FIG. 3, a procedure of a data transmission method provided in some embodiments includes the following steps.

401: A first service receiving device broadcasts a first MAC address to m service sending devices.

The service receiving device sends and receive an OTN frame through the OTN. The OTN frame includes an overhead area and a payload area. The payload area carries service data. The overhead area is also referred to as control overheads, and carries routing information of the service data and routing information of a device. Data transmission of the control overheads is not limited by an IP address or a MAC address of the device. The service receiving device sends, via the control overheads, data to each device that has a connection relationship with the service receiving device. In some embodiments, a device that has the connection relationship with the service receiving device and sends the service data to the service receiving device is referred to as a service sending device. In response to the network including n service receiving devices and the m service sending devices, where both m and n are integers greater than or equal to 1, the first service receiving device is any one of the n service receiving devices. The following describes the method in some embodiments by using cloud PE 1 as the first service receiving device.

In this embodiment, the cloud PE 1 is used as an example to describe each service receiving device. The cloud PE 1 constitutes no limitation on the service receiving device.

In response to the cloud PE 1 just accessing a communication network or a topology of a communication network changes, the cloud PE 1 broadcasts a first data frame to any CPE that has a connection relationship with the cloud PE 1. The first data frame carries a MAC address of the cloud PE 1.

A quantity of CPEs is m, and m CPEs represent each service sending device that has the connection relationship with the cloud PE 1 and that are in the communication network.

In this embodiment, the first data frame is an OTN frame. In response to the method in some embodiments being applied to another communication network, the first data frame is a data frame corresponding to the communication network. This is not limited herein.

In some embodiments, the MAC address of the service receiving device is also referred to as the first MAC address.

In some embodiments, the first MAC address is broadcast by using a packet of an extended protocol. The packet of the extended protocol, such as a BGP packet, includes a first data fragment, where the first data fragment indicates the first MAC address. The packet of the extended protocol is carried in a first field of the first data frame. The first MAC address is used by the service sending device to configure local routing information related to the service receiving device. In addition to the BGP packet, the packet of the extended protocol alternatively is a packet of another extended protocol, for example, a PCEP packet. This is not limited herein.

In some embodiments, in response to A carrying B, A is a location for placing B, but A is unable to completely accommodate B. Therefore, there is one or more As. Provided that A places content of B, A carries B. For example, the first field carries the BGP packet. In this case, content of one BGP packet is placed in a plurality of first fields, and each first field is for placing a part of the content of the BGP packet.

In response to the first data frame being an OTN frame, the first field is a GCC 0 in an overhead area of the OTN frame, or the first field is another field in the overhead area of the OTN frame, for example, a GCC 1 or a GCC 2. This is not limited herein. In response to the first data frame being a data frame of another communication network, the first field is correspondingly a field of the data frame of the another communication network. This is not limited herein.

Refer to Table 1. In an existing BGP protocol, a BGP packet supports carrying a path attributes object. The path attributes object includes a routing destination address and NEXT_HOP that indicates a next-hop IP address. In the scenario shown in FIG. 2, in response to a path attribute being a routing destination address, corresponding path attributes content is an IP address of a VPC. In response to a path attribute being NEXT_HOP, path attributes content is an IP address of a first port of a receiving device.

TABLE 1
Existing BGP packet

| Path attributes object | Path attributes content |
|---|---|
| Routing destination address | IP address of a VPC |
| NEXT_HOP | IP address of a first port |

In the existing BGP protocol, the BGP packet does not support carrying a MAC address. In addition, in the BGP protocol, no data fragment is specified to indicate the MAC address. In some embodiments, by using the extended protocol, that the first data fragment in the packet of the extended protocol indicates the MAC address of the service receiving device is specified. In this way, the MAC address of the service receiving device is transmitted.

Refer to Table 2. The BGP protocol is extended in some embodiments. A new path attribute is added to an extended BGP packet. The newly added path attribute is NEXT_HOP_MAC, indicating a MAC address of a next hop. NEXT_HOP_MAC is present together with the attribute NEXT_HOP in the BGP packet. In some embodiments, NEXT_HOP_MAC is the first data fragment.

TABLE 2
Extended BGP packet in some embodiments

| Path attributes object | Path attributes content |
|---|---|
| Routing destination address | IP address of a VPC |
| NEXT_HOP | First IP address |
| NEXT_HOP_MAC | First MAC address |

Each BGP packet in the method shown in some embodiments are extended BGP packets.

In response to the cloud PE 1 sending the BGP packet, the path attributes content of the path attribute NEXT_HOP in the packet is filled with an IP address of the cloud PE 1, and the path attributes content of the path attribute NEXT_HOP_MAC is filled with a MAC address of the cloud PE 1. The IP address herein is a device identifier of the cloud PE 1 and is also referred to as the first IP address. The device identifier identifies the receiving device. The MAC address herein is the MAC address of the cloud PE 1, and is also referred to as the first MAC address. The first MAC address is a MAC address of the receiving device. In some embodiments, a field for filling the first MAC address in the packet of the extended protocol further is referred to as a second field.

In some embodiments, the first IP address is an ID number of the receiving device, or is another device identifier identifying the receiving device, for example, a manually configured identification number. This is not limited herein.

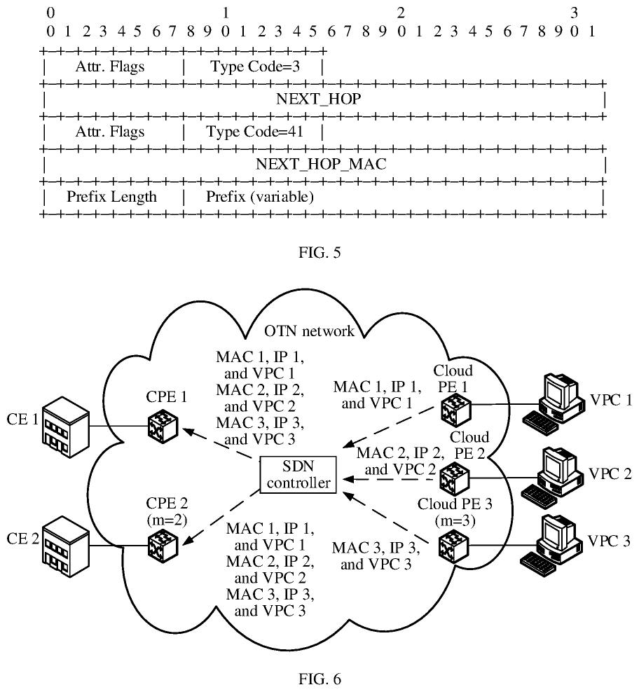

A format of the extended BGP packet is shown in FIG. 5. FIG. 5 is a schematic diagram of a format of an extended BGP protocol packet according to some embodiments. Attr. Flags in FIG. 5 indicate a flag bit of a path attribute. Type Code indicates a type of path attribute. Type Code 3 is NEXT_HOP, and Type Code 41 is NEXT_HOP_MAC. Prefix Length indicates a length of a prefix of a routing destination address. Prefix indicates a value of the prefix of the routing destination address.

The packet format shown in FIG. 5 is an example, and constitute no limitation on the extended BGP packet and the packet of the extended protocol.

402: Each of the m service sending devices configures local routing information based on the first MAC address.

In this embodiment, the service sending devices includes the CPE 1 and the CPE 2 in FIG. 3, and the service receiving devices includes the cloud PE 1, the cloud PE 2, and the cloud PE 3 in FIG. 3.

For example, after receiving the BGP packet sent by the cloud PE 1, each of the m CPEs configures local routing information related to the cloud PE 1, in other words, stores a mapping relationship between the first MAC address and the first IP address. Each CPE stores, in an ARP table of the CPE, the mapping relationship between the first IP address and the first MAC address in the BGP packet. In other words, the first IP address and the first MAC address are filled in the ARP table. The local routing information related to the cloud PE 1 alternatively exists in another form. For example, a mapping relationship between the first MAC address and the routing destination address, namely, a mapping relationship between the first MAC address and an IP address of the VPC 1 is stored locally. This is not limited herein. The VPC 1 is a device that is connected to the cloud PE 1 and that is configured to receive the service data.

In some embodiments, the ARP table is stored in a memory of the CPE instead of a cache. Therefore, once the mapping relationship between the first IP address and the first MAC address is stored, the mapping relationship is not overwritten by new data in the cache of the CPE. After this step, the CPE obtains the first MAC address based on the mapping relationship stored in the memory, and does not need to obtain the first MAC address by using another method, for example, by broadcasting an ARP request. The first MAC address is obtained by querying the ARP table stored in the memory. In this method, a success rate of obtaining the first MAC address is high.

Optionally, the CPE further stores a mapping relationship between the first IP address and the routing destination address in the BGP packet in a routing table of the CPE, that is, fill the routing table with the first IP address and the routing destination address. In some embodiments, the mapping relationship between the first IP address and the routing destination address in the routing table alternatively is obtained in another manner in addition to the packet of the extended protocol. For example, the mapping relationship between the first IP address and the routing destination address is manually configured. This is not limited herein.

In an example, this step further includes: The service sending device receives the service data and the IP address of the cloud VPC. In response to a CE calling to send the service data to a cloud VPC, for example, the CE 1 needs to send the service data to the cloud VPC 1, the CPE 1 connected to the CE 1 receives the foregoing service data and an IP address of the cloud VPC 1 from the CE 1, indicating that a receiver of the service data is the cloud VPC 1.

In some embodiments, the CE 1 and the cloud VPC 1 are used as examples, and constitute no limitation on a source and a destination of the service data.

In an example, after the MAC address sent by the service receiving device is received, this step further includes: The service sending device determines the first MAC address.

For example, after obtaining the IP address of the cloud VPC 1, the CPE 1 is configured to use the IP address of the cloud VPC 1 as the routing destination address, and query the routing table to obtain an IP address of the cloud PE 1 corresponding to the IP address of the cloud VPC 1, namely, the foregoing first IP address.

The CPE 1 then queries the ARP table stored in the memory to obtain the first MAC address corresponding to the first IP address. In this embodiment, the first MAC address is the MAC address of the cloud PE 1.

In response to the routing information configured by the CPE in step 302 being the mapping relationship between the first MAC address and the VPC, the CPE directly determines the first MAC address based on the mapping relationship and the IP address of the VPC. This is not limited herein.

403: At least one of the m service sending devices sends service data and the first MAC address to the first service receiving device based on the local routing information.

In this embodiment, the service sending devices includes the CPE 1 and the CPE 2 in FIG. 3, and the service receiving devices includes the cloud PE 1, the cloud PE 2, and the cloud PE 3 in FIG. 3.

For example, after obtaining the first MAC address, the CPE 1 sends the service data and the first MAC address to the cloud PE 1. The CPE 1 fills the payload area of the OTN frame with the service data obtained from the CE 1. Then, the routing destination address and the next-hop MAC address are filled in the control overheads of the OTN frame.

An object corresponding to the routing destination address in the control overheads are filled with the IP address of the cloud VPC 1. An object corresponding to the next-hop IP address in the control overheads is filled with the first IP address. An object corresponding to the next-hop MAC address in the control overheads is filled with the first MAC address.

The CPE 1 sends the OTN frame to the cloud PE 1.

In an example, after the MAC address sent by the service receiving device is received, this step further includes: The service receiving device transmits the service data to the cloud VPC.

For example, the cloud PE 1 receives the OTN frame, and verifies that the first MAC address carried in the control overheads of the OTN frame is the MAC address of the cloud PE 1, to determine that the OTN frame is sent to the cloud PE 1.

Then, the cloud PE 1 determines, based on the IP address of the VPC 1 carried in the control overheads of the OTN frame, that a receiver of the OTN frame is the cloud VPC 1, to transmit the service data to the cloud VPC 1.

In some embodiments, a quantity of service receiving devices is not limited to one, and there is a plurality of service receiving devices. For a correspondence of each receiving device and an action performed by each receiving device, refer to the cloud PE 1. Details are not described herein again.

In some embodiments, each of the m service sending devices configured with the local routing information sends a service message to the service receiving device. For a process in which any one of the m service sending devices sends the service message to the service receiving device, refer to a process in which the CPE 1 sends the service message. Details are not described herein again.

In some embodiments, the service sending device receives the MAC address of the service receiving device provided that the service sending device has the connection relationship with the service receiving device. The service sending device configures the local routing information based on the MAC address of the service receiving device. The service sending device successfully sends the service data based on the local routing information stored locally. Regardless of that the service sending device obtains the MAC address of the service receiving device or that the service sending device sends the service data to the service receiving device, network segments of IP addresses of the service sending device and the service receiving device do not constitute any limitation. Each service sending device and each service receiving device do not need to have a plurality of ports in different network segments, and a structure of the communication network is simpler. Planning personnel do not need to ensure that each pair of a service sending device and a service receiving device has ports in a same network segment, allowing planning more convenient.

In addition, the IP address of the service receiving device is directly used to identify the service receiving device. The planning person does not need to plan an IP address of a port of each service receiving device, so that an operation step of the planning person in the communication network is reduced, and an automation of the communication network is improved.

In some embodiments, the service sending device locally stores the MAC address of the service receiving device. In response to the service sending device sending the service data to the service receiving device, the MAC address of the service receiving device is directly obtained locally without obtaining the MAC address from another device. A bandwidth of the communication network is saved, and a delay is simultaneously reduced.

In the embodiment shown in FIG. 4, extension of the BGP packet is also applicable to a PCEP protocol, and newly added path attributes objects are both NEXT_HOP_MAC. Usage of an extended PCEP packet is the same as that of the extended BGP packet in the embodiment shown in FIG. 4. Details are not described herein again.

In some embodiments, the OTN architecture shown in FIG. 3 and the method shown in FIG. 4 are used as examples in some embodiments. The service data transmission method provided in some embodiments is not limited to the OTN network, and is alternatively applied to another communication network, for example, an ASON or a PTN. This is not limited herein.

In response to a plurality of service sending devices and a plurality of service receiving devices existing in the communication network, the MAC address of the service receiving device is transmitted by using a transit device, to reduce a quantity of messages in the communication network.

In some embodiments, the transit device is configured to reduce a quantity of messages for transmitting the MAC address of the service receiving device in the communication network. The transit device is a software-defined networking (SDN) controller. Alternatively, the transit device is another device, for example, a server or a network element. This is not limited herein. In some embodiments, the SDN controller is used as an example, and constitutes no limitation on the transit device.

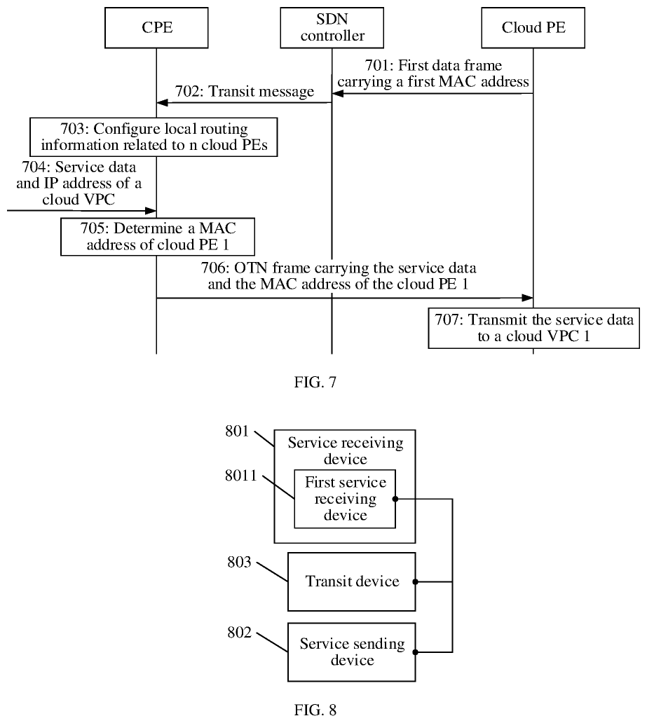

FIG. 6 is an architectural diagram of a communication network according to some embodiments. In this architecture, a transit device is used to reduce a quantity of message for transmitting a first MAC address in a communication network. The communication network includes m CPEs and n cloud PEs. Both m and n are integers greater than 1. Based on the network architecture shown in FIG. 6, a method shown in FIG. 7 is implemented.

In some embodiments, the CPE and the cloud PE in some embodiments are examples of a service sending device and a service receiving device, and constitute no limitation. For details about possibilities of the service sending device and the service receiving device, refer to the embodiment shown in FIG. 4. Details are not described herein again.

FIG. 7 is a schematic flowchart of a data transmission method according to some embodiments. Refer to FIG. 7. Based on the architecture of the communication network shown in FIG. 6, a procedure of a data transmission method provided in some embodiments includes the following steps.

701: n cloud PEs send, to an SDN controller, a first data frame carrying a first MAC address.

In response to the n cloud PEs just accessing a communication network or a topology of a communication network changes, each of the n cloud PEs sends, to the SDN controller, the first data frame carrying the first MAC address. The first data frame sent by each service receiving device carries a MAC address of the service receiving device, namely, the first MAC address. In other words, the SDN controller receives n MAC addresses from the n cloud PEs. The n MAC addresses are different from each other, and the n MAC addresses are in one-to-one correspondence with the n cloud PEs. For example, x^{th} cloud PE in the n cloud PEs sends the first data frame to the SDN controller. The frame carries a MAC address and an IP address of the x^{th} cloud PE, and an IP address of a VPC connected to the x^{th} cloud PE. The x^{th} cloud PE is any one of the n cloud PEs.

The first MAC address is transmitted via a packet of an extended protocol, such as a BGP protocol. For details, refer to step 401 in the embodiment shown in FIG. 4. Details are not described herein again.

In some embodiments, a message including the MAC address of the service receiving device further is referred to as a routing message. Cloud PE 1 is used as an example. The cloud PE 1 sends, to the SDN controller, a routing message that includes MAC 1, IP 1, and VPC 1, where MAC 1 is a MAC address of the cloud PE 1, IP 1 is an IP address of the cloud PE 1, and VPC 1 is an IP address of a VPC 1.

702: The SDN controller broadcasts a transit message to the m CPEs.

After receiving the MAC address and the IP address of the x^{th} cloud PE and the IP address of the VPC connected to the x^{th} cloud PE that are sent by the n cloud PEs, the SDN controller broadcasts the transit message to each of the m CPEs. Each transit message includes MAC addresses and IP addresses of the n cloud PEs, and IP addresses of VPCs connected to the n cloud PEs. The MAC address and the IP address of the x^{th} cloud PE and the IP address of the VPC connected to the x^{th} cloud PE are carried in a BGP packet. x is an integer from 1 to n.

In some embodiments, the transit message is sent via an OTN frame. In this case, the OTN frame further is referred to as a second data frame. The second data frame carries the MAC addresses of the n service receiving devices.

For a relationship between the second data frame and the BGP packet, refer to a relationship between the first data frame and the BGP packet in step 401 in the embodiment shown in FIG. 4. Details are not described herein again. For locations of the MAC address and the IP address of the x^{th} cloud PE and the IP address of the VPC connected to the x^{th} cloud PE in the BGP packet, refer to the descriptions of step 401 in the implementation example in FIG. 4. Details are not described herein again.

703: Each piece of CPE configures local routing information related to the n cloud PEs.

Each piece of CPE configures the local routing information related to the n cloud PEs. Each piece of CPE configures, based on the MAC address and the IP address of the x^{th} cloud PE and the IP address of the VPC connected to the x^{th} cloud PE, routing information related to the x^{th} cloud PE. x is an integer from 1 to n.

For a process of configuring the routing information, refer to the embodiment shown in FIG. 4. Details are not described herein again.

704: CPE 1 receives service data and an IP address of a cloud VPC.

At least one of the n CPEs receives the service data and the IP address of the cloud VPC, where the cloud VPC is connected to one of the m cloud PEs. For example, the CPE 1 receives the service data and the IP address of the VPC 1, where the VPC 1 is connected to the cloud PE 1. The CPE 1 represents any one of the m CPEs. The cloud PE 1 represents any one of the n cloud PEs. In some embodiments, the CPE 1 and the cloud PE 1 are used as examples, and constitute no limitation on the service sending device and the service receiving device.

705: The CPE 1 determines the MAC address of the cloud PE 1.

After receiving the IP address of the VPC 1, the CPE 1 obtains the MAC address of the cloud PE 1 based on the routing information that is related to the cloud PE 1 and that is configured in step 703. For a process of obtaining the MAC address of the cloud PE 1, refer to the embodiment shown in FIG. 4. Details are not described herein again.

706: The CPE 1 sends, to the cloud PE 1, an OTN frame carrying the service data and the MAC address of the cloud PE 1.

After obtaining the MAC address of the cloud PE 1, the CPE 1 sends, to the cloud PE 1, the OTN frame carrying the service data and the MAC address of the cloud PE 1. For locations of the service data and the MAC address in the OTN frame, refer to the embodiment shown in FIG. 4. Details are not described herein again.

707: The cloud PE 1 transmits the service data to a cloud VPC 1.

The cloud PE 1 receives the OTN frame, and verifies that the MAC address carried in control overheads of the OTN frame is the MAC address of the cloud PE 1, to determine that the OTN frame is sent to the cloud PE 1.

Then, the cloud PE 1 determines, based on the IP address of the VPC 1 carried in the control overheads of the OTN frame, that a receiver of the OTN frame is the cloud VPC 1 connected to the cloud PE 1, to transmit the service data to the cloud VPC 1.

In some embodiments, in response to there being no transit device, the n service receiving devices send the MAC addresses of the service receiving devices to the m service sending devices, that is, a total of m*n messages need to be sent. With the transit device, the n service receiving devices need to send a total of m+n messages, to send the MAC addresses of the service receiving devices to the m service sending devices. In response to both m and n being integers greater than 1, m*n>m+n. The transit device sends the MAC addresses of the service receiving devices, so that a quantity of messages in the communication network is reduced, and a bandwidth of the communication network is saved.

The following describes the communication network in some embodiments. Refer to FIG. 8. In some embodiments, a structure of a communication network includes:

n service receiving devices 801 and m service sending devices 802, where both n and m are integers greater than or equal to 1.

The n service receiving devices 801 include a first service receiving device 8011, and the first service receiving device 8011 is any one of the n service receiving devices 801.

The first service receiving device 8011 is configured to broadcast a first MAC address to the m service sending devices 802, where the first MAC address is a MAC address of the first service receiving device 8011.

Each of the m service sending devices 802 is configured to configure local routing information based on the first MAC address.

At least one of the m service sending devices 802 is configured to send service data and the first MAC address to the first service receiving device 8011 based on the local routing information.

In an example, the first service receiving device 8011 is configured to send a first data frame to each service sending device, where the first data frame includes a first field, and the first field carries the first MAC address.

In an example, the first data frame is an OTN frame, and the first field is located in an overhead area of the OTN frame.

In an example, the first field carries a packet of an extended protocol, and the packet of the extended protocol indicates the first MAC address.

In an example, the communication network further includes a transit device 803.

The transit device 803 is configured to receive n MAC addresses from the n service receiving devices 801, where the n MAC addresses are in one-to-one correspondence with the n service receiving devices; and forward the n MAC addresses to each service sending device.

Each of the m service sending devices 802 is configured to configure the local routing information based on the n MAC addresses, where the local routing information corresponds to the n service receiving devices.

In an example, the transit device 803 is configured to send a second data frame to each service sending device, where the second data frame includes a second field, and the second field indicates a MAC address of each of the n service receiving devices.

In an example, the transit device 803 includes at least one of the following: a software-defined networking SDN controller, a server, or a network element.

In an example, the first service receiving device 8011 is configured to broadcast the first MAC address and a device identifier of the first service receiving device to the m service sending devices.

Each of the m service sending devices 802 is configured to configure the local routing information based on the first MAC address and the device identifier.

The communication network shown in FIG. 8 is configured to perform the method in the embodiment shown in FIG. 4 or FIG. 6.

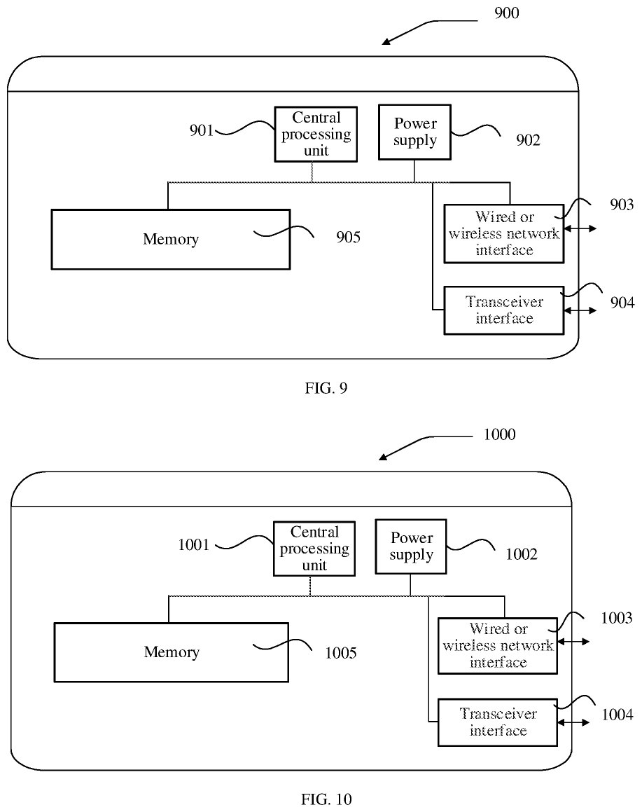

The following describes the service receiving device in some embodiments. FIG. 9 is a schematic diagram of a structure of a service receiving device according to some embodiments. The service receiving device 900 includes one or more central processing units (CPUs) 901 and a memory 905. The memory 905 stores one or more application programs or data.

The memory 905 is a volatile memory or a persistent memory. The programs stored in the memory 905 includes one or more modules, and each module includes a series of instruction operations for the service receiving device. Further, the central processing unit 901 is configured to communicate with the memory 905, and perform the series of instruction operations in the memory 905 on the service receiving device 900.

The service receiving device 900 further includes one or more power supplies 902, one or more wired or wireless network interfaces 903, one or more transceiver interfaces 904, and/or one or more operating systems such as Windows Server™, Mac OS X™, Unix™, Linux™, and FreeBSD™.

The service receiving device 900 performs operations performed by the service receiving device in the embodiment shown in FIG. 4, FIG. 6, or FIG. 7. Details are not described herein again.

The following describes the service sending device in some embodiments. FIG. 10 is a schematic diagram of a structure of a service sending device according to some embodiments. The service sending device 1000 includes one or more central processing units (CPUs) 1001 and a memory 1005. The memory 1005 stores one or more application programs or data.

The memory 1005 is a volatile memory or a persistent memory. The programs stored in the memory 1005 includes one or more modules, and each module includes a series of instruction operations for the service sending device. Further, the central processing unit 1001 is configured to communicate with the memory 1005, and perform the series of instruction operations in the memory 1005 on the service sending device 1000.

The service sending device 1000 further includes one or more power supplies 1002, one or more wired or wireless network interfaces 1003, one or more transceiver interfaces 1004, and/or one or more operating systems such as Windows Server™, Mac OS X™, Unix™, Linux™, and FreeBSD™.

The service sending device 1000 performs operations performed by the service sending device in the embodiment shown in FIG. 4, FIG. 6, or FIG. 7. Details are not described herein again.

A person skilled in the art is able to clearly understood that, for the purpose of convenient and brief description, for a detailed working process of the foregoing system, apparatus, and unit, refer to a corresponding process in the foregoing method embodiments, and details are not described herein again.

In the several embodiments, the disclosed system, apparatus, and method is implemented in other manners. For example, the described apparatus embodiment is an example. For example, division into the units is logical function division and is other division in implementation. For example, a plurality of units or components are combined or integrated into another system, or some features are ignored or not performed. In addition, the displayed or discussed mutual couplings or direct couplings or communication connections are implemented through some interfaces. The indirect couplings or communication connections between the apparatuses or units are implemented in electronic, mechanical, or other forms.

The units described as separate parts are or are unable to be physically separate, and parts displayed as units are or are unable to be physical units, is located in one position, or is distributed on a plurality of network units. Some or all the units are selected based on conditions to achieve the objectives of the solutions of embodiments.

In addition, functional units in some embodiments are integrated into one processing unit, each of the units exists alone physically, or two or more units are integrated into one unit. The integrated unit is implemented in a form of hardware, or is implemented in a form of a software functional unit.

In response to the integrated unit being implemented in the form of the software functional unit and sold or used as an independent product, the integrated unit is stored in a computer-readable storage medium. Based on such an understanding, the technical solutions of the embodiments, or the part contributing to the prior art, or all or some of the technical solutions are implemented in the form of a software product. The computer software product is stored in a storage medium and includes several instructions for instructing a computer device (which is a personal computer, a server, or a network device) to perform all or some of the steps of the methods described in some embodiments. The foregoing storage medium includes any medium that stores program code, such as a USB flash drive, a removable hard disk, a read-only memory (ROM), a random access memory (RAM), a magnetic disk, or an optical disc.

What is claimed is:

1. A service data transmission method, comprising:
broadcasting, by a first service receiving device, a first MAC address to m service sending devices, wherein:
the first service receiving device is any one of n service receiving devices;
the first MAC address is a MAC address of the first service receiving device;
the n service receiving devices and the m service sending devices are included in a communication network; and
n and m are integers greater than or equal to 1; and
configuring, by each of the m service sending devices, local routing information based on the first MAC address; and
sending, by at least one of the m service sending devices, service data and the first MAC address to the first service receiving device based on the local routing information.

2. The method according to claim 1, wherein:
the broadcasting, by the first service receiving device, the first MAC address to the m service sending devices comprises:
sending, by the first service receiving device, a first data frame to each service sending device, wherein the first data frame includes a first field that carries the first MAC address.

3. The method according to claim 2, wherein:
the first data frame is an optical transport network (OTN) frame; and
the first field is located in an overhead area of the OTN frame.

4. The method according to claim 3, wherein:
the first field carrying the first MAC address includes a packet of an extended protocol that indicates the first MAC address.

5. The method according to claim 1, wherein:
the broadcasting, by the first service receiving device, the first MAC address to the m service sending devices comprises:
receiving, by a transit device included in the communication network, n MAC addresses from the n service receiving devices, wherein the n MAC addresses are in one-to-one correspondence with the n service receiving devices;
forwarding, by the transit device, the n MAC addresses to each service sending device; and
configuring, by each service sending device, the local routing information based on the n MAC addresses.

6. The method according to claim 5, wherein:
the forwarding, by the transit device, the n MAC addresses to each service sending device comprises:
sending, by the transit device, a second data frame to each service sending device, wherein the second data frame includes a second field that indicates a MAC address of each of the n service receiving devices.

7. The method according to claim 5, wherein:
the transit device includes at least one of the following:
a software-defined networking SDN controller;
a server; or
a network element.

8. The method according to claim 1, wherein:
the broadcasting, by the first service receiving device, the first MAC address to the m service sending devices comprises:
broadcasting, by the first service receiving device, the first MAC address and a device identifier of the first service receiving device to the m service sending devices; and
the configuring, by each of the m service sending devices, the local routing information based on the first MAC address comprises:
configuring, by each service sending device, the local routing information based on the first MAC address and the device identifier.

9. A communication network, comprises:
n service receiving devices; and
m service sending devices, wherein:
n and m are integers greater than or equal to 1; and
a first service receiving device is any one of the n service receiving devices, wherein:
the first service receiving device is configured to broadcast a first MAC address to the m service sending devices, wherein:
the first MAC address is a MAC address of the first service receiving device;
each of the m service sending devices is configured to configure local routing information based on the first MAC address; and
at least one of the m service sending devices is configured to send service data and the first MAC address to the first service receiving device based on the local routing information.

10. The communication network according to claim 9, wherein:
the first service receiving device is configured to send a first data frame to each service sending device, wherein the first data frame includes a first field that carries the first MAC address.

11. The communication network according to claim 10, wherein:
the first field carrying the first MAC address includes a packet of an extended protocol that indicates the first MAC address.

12. The communication network according to claim 9, further comprises:
a transit device configured to:
receive n MAC addresses from the n service receiving devices, wherein the n MAC addresses are in one-to-one correspondence with the n service receiving devices;
forward the n MAC addresses to each service sending device; and
each service sending device is configured to configure the local routing information based on the n MAC addresses.

13. The communication network according to claim 12, wherein:
the transit device is configured to send a second data frame to each service sending device, wherein the second data frame includes a second field that indicates a MAC address of each of the n service receiving devices.

14. The communication network according to claim 12, wherein:
the transit device is at least one of:
a software-defined networking (SDN) controller;
a server; or
a network element.

15. The communication network according to claim 9, wherein:
the first service receiving device is configured to broadcast the first MAC address and a device identifier of the first service receiving device to the m service sending devices; and
each service sending device is configured to configure the local routing information based on the first MAC address and the device identifier.

16. A non-transitory computer readable medium, wherein the non-transitory computer readable medium stores a program, and in response to a computer executing the program, cause a communication network to:
broadcast, by a first service receiving device, a first MAC address to m service sending devices, wherein:
the first service receiving device is any one of n service receiving devices, the first MAC address is a MAC address of the first service receiving device; and
the first MAC address is used by each of the m service sending devices to configure local routing information; and
receive, by the first service receiving device, service data and the first MAC address, wherein the service data and the first MAC address are sent by at least one of the m service sending devices based on the local routing information.

17. The non-transitory computer readable medium according to claim 16, wherein:
the broadcasting, by the first service receiving device, the first MAC address to m service sending devices comprises:
send, by the first service receiving device, a first data frame to each service sending device, wherein the first data frame includes a first field that carries the first MAC address.

18. The non-transitory computer readable medium according to claim 17, wherein:
the first field carrying the first MAC address includes a packet of an extended protocol that indicates the first MAC address.

19. The non-transitory computer readable medium according to claim 16, wherein:
the broadcasting, by the first service receiving device, the first MAC address to m service sending devices comprises:
send, by the n service receiving devices, n MAC addresses to a transit device, wherein the n MAC addresses are in one-to-one correspondence with the n service receiving devices, and the n MAC addresses are forwarded to each service sending device.

20. The non-transitory computer readable medium according to claim 16, wherein:
the broadcasting, by the first service receiving device, the first MAC address to m service sending devices comprises:
broadcast, by the first service receiving device, the first MAC address and a device identifier of the first service receiving device to the m service sending devices, wherein the first MAC address and the device identifier are used by each service sending device to configure the local routing information.
